(19) United States
(12) Patent Application Publication
(10) Pub. No.: US 2008/0274311 A1
(43) Pub. Date: Nov. 6, 2008

(54) Protective Tube

(76) Inventors: Jordi Relats Manent, Caldes de Montbui (Barcelona) (ES); Pere Relats Casas, Caldes de Montbui (Barcelona) (ES); Dolors Artola Sole, Caldes de Montbui (Barcelona) (ES); Anna Fruns Martin, Caldes de Montbui (Barcelona) (ES); Joaquim Salas Duran, Caldes de Montbui (Barcelona) (ES)

Correspondence Address: NATH & ASSOCIATES, 112 South West Street, Alexandria, VA, 22314, US

(21) Appl. No.: 10/589,745

(22) PCT Filed: May 18, 2005
(86) PCT No.: PCT/ES2005/000276

§ 371 Date: Jul. 11, 2008

(30) Foreign Application Priority Data
May 19, 2004 (ES) P200401196

(51) Int. Cl. B29D 22/00

(52) U.S. Cl. 428/34.5

(57) ABSTRACT

The invention relates to a protective tube comprising a plurality of threads which are braided, knit-braided or knitted to one another. The invention is characterised in that the length of the cross-section of the threads along a first axis is substantially greater than the length of said cross-section along a second axis which is perpendicular to the first.

The invention refers to a thermal and mechanical protective tube for cables, conduits and similar items.

### BACKGROUND TO THE INVENTION

The use of braided tubes to protect bunches of cables applicable to assemblies in cars is known. The majority of these braided cables are made from a monofilament threads of polymeric material with a circular cross-section.

The use of these types of threads is advantageous for several reasons. One of them consists of the fact that it allows maximum expansion of the tube's section when the length of same is contracted, allowing the introduction of the bunch of cables inside of the tube and returning to its original section when the force is removed that has been used to contract the length.

Another advantage of this type of thread is that they have high resistance to abrasion from friction.

In addition, in line with the type of polymer material that is used in the manufacture of the threads, the tube has a good resistance to temperature and good thermal insulation.

One of the properties that the braided tubes have to exhibit for the application described is that they must have a high surface cover factor (more than 80%) in order to prevent any of the cables contained being able to cross the tube wall during its protection function, being uncovered and as a consequence, unprotected.

The value for the surface cover factor is determined by a series of variables related to the tube's characteristics, amongst which the diameter of the thread used in the manufacture of the tube has a great influence.

In this way, in order to achieve tubes with a high surface cover factor it is necessary to use monofilaments with a high diameter, with the result that the braided tubes obtained are heavy and have a high cost.

### DESCRIPTION OF THE INVENTION

The aim of this present invention is the solving of the disadvantages presented by the devices already known in the present technology, providing a protective tube that is made up of a plurality of threads that are braided, knit-braided or knitted to one another. The invention is characterised in that the length of the cross section of the threads along a first axis or direction is substantially greater than the length of said cross section along a second axis which is perpendicular to the first.

Thanks to these characteristics, a braided tube is obtained with less weight and thus at less cost than the tubes that use circular cross section threads whilst still keeping the other properties: capacity of expansion and retraction, resistance to abrasion and thermal performance without significant changes.

By preference, the length of the cross section in the first axis is at least 1.5 times greater than the length of said cross section of the second axis that is perpendicular to said first axis.

Advantageously, the threads of the tube are made from a polymeric material.

According to another aspect of the invention, the polymeric material used for said threads can be polyamide, polyester, polypropylene, polyethylene or phenylen polysulphide.

### BRIEF DESCRIPTION OF THE INVENTION

In order to make the description easier in regard to that stated above some drawings are attached in which, in form of an outline has been shown by way of example but not by way of being a limitation, a practical case of an embodiment of the tube of the invention is included, in which:

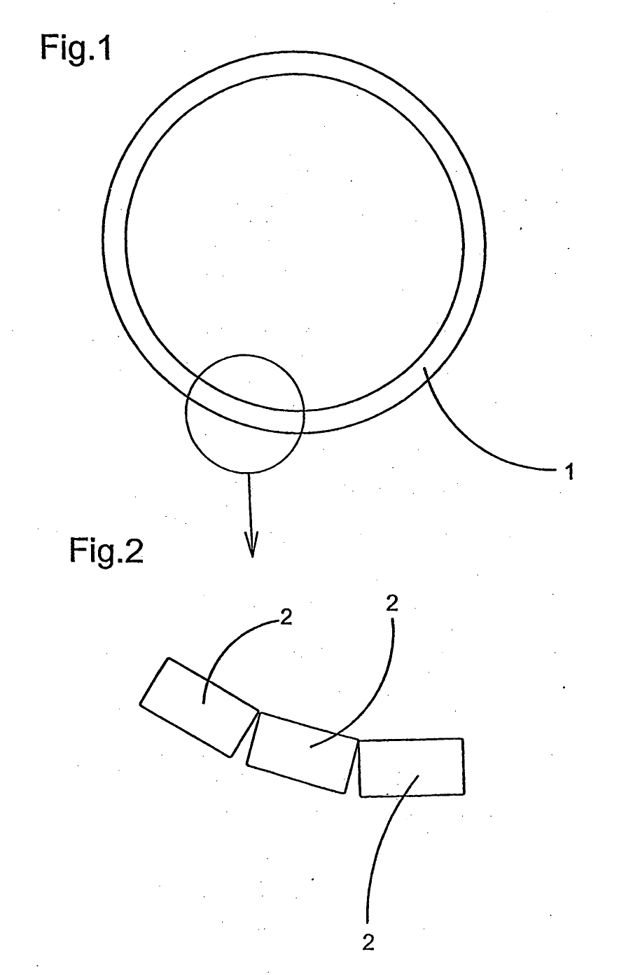

FIG. 1 is an outline transversal cross section of the protective tube of the present invention; and

FIG. 2 is a detail of one of the threads that make up the tube of this present invention.

### DESCRIPTION OF A PREFERRED EMBODIMENT

As and how can be appreciated in the figures, the tube (1) of this present invention comprises a plurality of threads (2) which are braided, knit-braided, or knitted to one another. In the embodiment these threads (2) have a rectangular cross section, even though said cross section could have an oval, polygonal or any other shape that fulfils the necessary conditions.

Thanks to said arrangement, the threads (2) cover the cables disposed on the inside of the tube (1) in a more effective manner, the thickness of same being much less than that used for circular cross section threads.

A practical case is described below in which the advantages of the tube of the present invention are shown.

According to the section 5.4 of the Volvo STD 7821.2 Standard, the superficial cover factor (K) of a braided tube using monofilament type threads has been calculated by the following formula:

K=100·(2·F−F²)% in which F=(N·P·d)/(25·senα) and

tga=2·π·(D+2d)·P/(C·25)

Where:

F=fill factor

N=Number of monofilament threads per coil

P=number of crosses per 25 mm

d=diameter of monofilament in mm

α=braiding angle in degrees in regard to the longitudinal axis

D=diameter situated on the inside of the braiding in mm

C=number of machine coils to be braided

In order to use said tubes in cars for the protection of cables and similar items, the superficial cover factor K must be not less than 80%.

The values obtained with a standard tube made respectively with circular cross section threads and with rectangular cross section threads are as follows:

Standard Tube

Polymer that makes up the threads: polyester

Dimension of the threads: 0.22 mm diameter

N^{o} of machine coils to be braided: 80

N^{o} of threads per coil: 3

N^{o} of crosses in the braiding: 15/30 mm

Nominal diameter of the tube: 20 mm

Maximum expansion diameter of the tube: 27 mm

Tube lineal metre weight: 17 gr

Superficial cover factor: 78%

Tube Made Out of Rectangular Cross-Section Threads

Polymer that makes up the threads: polyester

Dimension of the threads: 0.14×0.26 mm diameter

N^{o} of machine coils to be braided: 80

N^{o} of threads per coil: 3

N^{o} of crosses in the braiding: 15/30 mm

Nominal diameter of the tube: 20 mm

Maximum expansion diameter of the tube: 27 mm

Tube lineal metre weight: 17 gr

Superficial cover factor: 86% (taking 0.26 mm as the monofilament diameter in the formula)

As can be seen, with the preferred embodiment stated an increase in the superficial cover factor of the braided tube is achieved of 10%, keeping the lineal metre weight of the same.

1. Protective tube (1) comprising a plurality of threads (2) which are braided, knit-braided, or knitted to one another, characterised in that the length of the cross section of the threads (2) along a first axis is substantially greater than the length of said cross section along a second axis which is perpendicular to the first.

2. Tube (1) according to claim 1, characterised in that the length of the cross section of the first axis is at least 1.5 times greater than the length of said cross section of the second axis which is perpendicular to the first.

3. Tube (1) according to claims 1 or 2, characterised in that said threads (2) are made from a polymeric material.

4. Tube (1) according to claim 3, characterised in that said polymeric material is polyamide.

5. Tube (1) according to claim 3, characterised in that said polymeric material is polyester.

6. Tube (1) according to claim 3, characterised in that said polymeric material is polypropylene.

7. Tube (1) according to claim 3, characterised in that said polymeric material is polyethylene.

8. Tube (1) according to claim 3, characterised in that said polymeric material is phenylen polysulphide.
